(19) United States
(12) Patent Application Publication
(10) Pub. No.: US 2010/0001970 A1
(43) Pub. Date: Jan. 7, 2010

(54) ACTIVE MATRIX DISPLAY APPARATUS WITH TOUCH SENSING FUNCTION

(75) Inventor: Keitaro Yamashita, Kobe (JP)

Correspondence Address: LIU & LIU, 444 S. FLOWER STREET, SUITE 1750, LOS ANGELES, CA, 90071, US

(73) Assignee: TPO Displays Corp., Chu-Nan (TW)

(21) Appl. No.: 12/497,451

(22) Filed: Jul. 2, 2009

(30) Foreign Application Priority Data
Jul. 4, 2008 (JP) 2008-176069

(51) Int. Cl. G06F 3/041

(52) U.S. Cl. 345/173; 345/55

(57) ABSTRACT

An active matrix display apparatus with touch sensing function having high aperture ratio includes a plurality of pixels, having respective pixels arrayed as a matrix, positioned at intersections of source lines of respective columns and gate lines of respective rows, each pixel having a thin film transistor and a liquid crystal element, which is positioned between a drain of thin film transistors and a common line; and a touch switch unit having touch sensing transistors and a mechanical switch, which is positioned between two adjacent pixels in an identical column. The gates of the touch sensing transistors are coupled to the gate lines of the two adjacent pixels wherein the touch sensing transistors coupled in series and the mechanical switch shared by the adjacent pixels, are coupled between the source line of the identical column and the common line.

### BACKGROUND OF THE INVENTION

1. Field of the Invention

The present invention generally relates to an active matrix display apparatus, and more particularly to an active matrix display apparatus with touch sensing function.

2. Description of Prior Art

An LCD with touch sensing function can detect the capacitance change, resistance change or reflection of the infrared ray due to the touch event of a finger or a stylus occurring to the LCD screen in order to input data and operation commands. A pressure sensing film is necessary to be adhered on the glass substrate of the LCD of the pressure sensing type (e.g. mechanical sensing) by detecting resistance change with the pressure variation. However, transparency or other optical properties of such a pressure sensing film are not good enough and thus resulting in problems of poor display quality and narrow viewing angles. As for the capacitance sensing type, problems of strong noises may occur; as for the light sensing type, mal-operations due to sunlight or dust may occur from time to time.

Please refer to FIG. 1, which depicts a profile of a general mechanical touch sensing construction of a pixel according to prior arts. An array glass 1 and a color filter glass 2 are arranged in opposite. Spacers 3, which are deformable as being subject to pressure, are positioned at borders of pixels between the array glass 1 and the color filter glass 2. Protuberance-like sensor terminals 4 are located above the array glass 1. Conductive films 5, such as ITO films, are formed on the surfaces of the sensor terminals 4. Meanwhile, a common electrode 6, which can be formed by an ITO film, is formed under the color filter glass 2. The distance between the conductive films 5 and the common electrode 6 is generally set about 1-4 μm. Display liquid crystal and TFT are not shown for simplicity.

In the touch sensing elements, when the pressure is exerted by the finger or the stylus from the upward side of the color filter glass 2, the spacers 3 are compressed. With contact and accordingly conduction occur between the common electrode 6 under the color filter glass 2 and the conductive films 5 above the array glass 1, the resistance therebetween drops, and a sensing amplifier can be utilized for detecting the resistance change so as to determine the touch position.

Please refer to FIG. 2, which depicts an electrical circuit of the pixel shown in FIG. 1 according to prior arts. The gate of a thin Film Transistor TFT is coupled with a gate line GL, which is a row selection line, and the source of the thin film transistor TFT is coupled with a source line SL, which is a column selection line. The liquid crystal element Clc and the switch S are coupled between the drain of the thin film transistor TFT and a common electrode CE. Meanwhile, one terminal of an auxiliary capacitor CS is coupled with the drain of the thin film transistor TFT. The other terminal of the auxiliary capacitor CS is coupled with an auxiliary capacitor line CSL of the same row. The switch S comprises the common electrode 6 under the color filter glass 2 and the conductive films 5 above the array glass 1 shown in FIG. 1. The connection points of the liquid crystal element Clc and the switch S shown in FIG. 2 are corresponding to the sensor terminals 4 and the conductive films 5 on the sensor terminals 4 as shown in FIG. 1.

In FIG. 2, the thin film transistor TFT is turned on when the row is selected and the gate line GL becomes to be at a high potential. When the switch S is closed as being touched, the potential of the pixel electrode (e.g. sensor terminals) 4 becomes the same as that of the common electrode CE and the potential of the source line SL becomes to be equal to the potential of the common electrode CE. A sensing amplifier can be utilized to detect the potential change of the source line SL to determine whether a touch event occurs to the pixel or not. In a practical LCD equipment, by activating the sensing amplifiers of the respective columns and sequentially scanning the gate lines of the LCD from top to bottom, it can be detected that the mechanical switch S at which column and at which row is turned on.

However, in such a structure, the switch S is closed and turned on nearby the liquid crystal element Clc, the problem of display color may occur. Taking a normally white liquid crystal element as an example, the liquid crystal element which is touched by the finger or the stylus will become white under the condition of displaying a black screen. Moreover, once the switch S has a defect, not only the touch sensing function cannot work, but the display problems also occur.

Furthermore, each pixel must be provided with a switch S. Those switches occupy a certain area, and therefore the effective display area is reduced and the aperture ratio is decreased. Japan patent publication 2001-75074 is incorporated herein entirely by reference.

### SUMMARY OF THE INVENTION

An objective of the present invention is to provide an active matrix display apparatus with touch sensing function, which has efficient area usage for ensuring high aperture ratio and good display quality.

The active matrix display apparatus with touch sensing function of the present invention comprises a plurality of pixels arrayed as a matrix, respectively positioned at intersections of source lines of respective columns and gate lines of respective rows, each pixel having a thin film transistor and a liquid crystal element which is positioned between a drain of thin film transistor and a common line, wherein sources of the thin film transistors of the pixels are coupled to the source lines and gates thereof are coupled to the gate lines; and a touch switch unit having two touch sensing transistors and a mechanical switch. The touch switch unit is positioned between two adjacent pixels of an identical column and gates of the two touch sensing transistors are coupled to the gate lines of the adjacent pixels, wherein the two touch sensing transistors are coupled in series and the mechanical switch is shared by the two adjacent pixels. The two touch sensing transistors and the mechanical switch are coupled between the source line of the identical column and the common line.

Moreover, according to the present invention, the touch switch unit is formed with the two touch sensing transistors and the mechanical switch. The touch sensing transistors are coupled and activated by the respective gate lines of the two adjacent pixels of the identical column. The mechanical switch is shared by the two adjacent pixels of the identical column, and is coupled between the source line of the identical column and common line. Accordingly, the upper and lower adjacent pixels share the mechanical switch. In addition, the touch sensing function can be realized by utilizing the existing gate lines, therefore, the present invention requires a smaller occupied area for establishing the touch sensing function in comparison to prior arts. Consequently, an active matrix display apparatus having high aperture ratio can be realized.

### BRIEF DESCRIPTION OF THE DRAWINGS

FIG. 1 depicts a profile of a general mechanical touch sensing element according to prior arts.

FIG. 2 depicts a circuit of a pixel including a mechanical switch according to prior arts.

FIG. 3 illustrates a circuit of an active matrix display apparatus according to the present invention.

FIG. 4 shows a timing diagram of touch sensing and display motions of the active matrix display apparatus of FIG. 3 when the active matrix display apparatus is a color active matrix display apparatus.

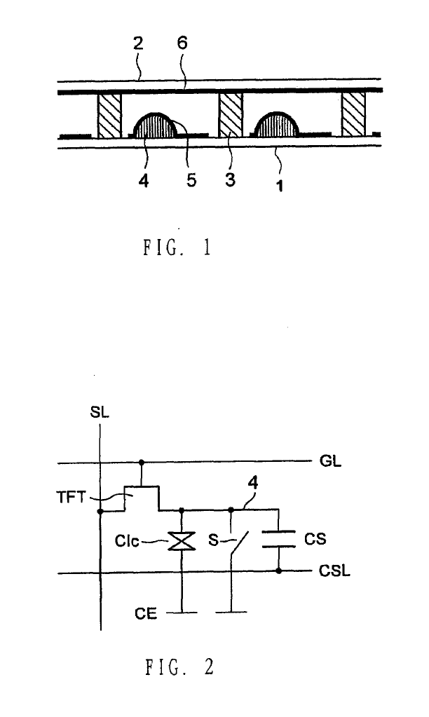

### DETAILED DESCRIPTION OF THE INVENTION

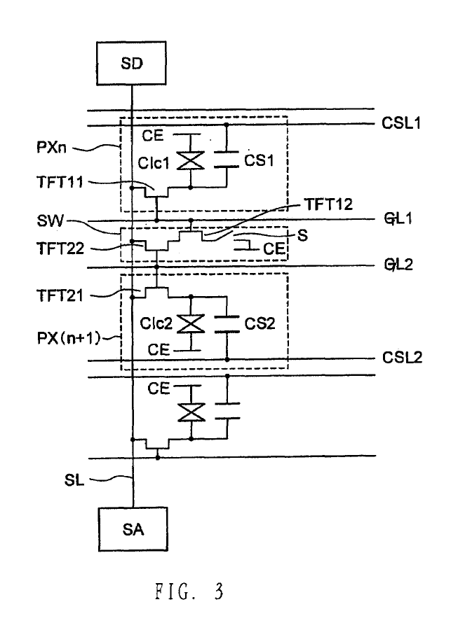

Please refer to FIG. 3, which illustrates a circuit of an active matrix display apparatus according to the present invention. FIG. 3 shows pixels PXn and PX(n+1) of the n^{th} row and the (n+1)^{th} row of an identical column and a mechanical switch positioned therebetween.

The pixel PXn comprises a thin film transistor TFT11, a liquid crystal element Clc1 and an auxiliary capacitor CS1. The source of the thin film transistor TFT11 is coupled with a source line SL and the gate of the thin film transistor TFT11 is coupled with a gate line GL1. The liquid crystal element Clc1 is positioned between the drain of the thin film transistor TFT11 and a common electrode CE. The auxiliary capacitor CS1 is positioned between the drain of the thin film transistor TFT11 and an auxiliary capacitor line CSL1. Similarly, the pixel PX(n+1) comprises a thin film transistor TFT21, a liquid crystal element Clc2, and an auxiliary capacitor CS2. The source of the thin film transistor TFT21 is coupled with the source line SL and the gate of the thin film transistor TFT21 is coupled with a gate line GL2. The liquid crystal element Clc2 is positioned between the drain of the thin film transistor TFT21 and the common electrode CE. The auxiliary capacitor CS2 is positioned between the drain of the thin film transistor TFT21 and an auxiliary capacitor line CSL2.

The gate lines GL1 and GL2 are arranged closely in parallel. Therefore, the pixel PXn and the pixel PX(n+1) are symmetrically constructed in the column direction in respect to the gate lines GL1 and GL2. A touch switch unit SW is formed between the gate lines GL1 and GL2. The touch switch unit SW comprises a thin film transistor TFT22, a thin film transistor TFT12 and a mechanical switch S. The source of the thin film transistor TFT22 is coupled with the source line SL. The gate of the thin film transistor TFT22 is coupled with the gate line GL2. The source of the thin film transistor TFT12 is coupled with the drain of the thin film transistor TFT22. The gate of the thin film transistor TFT12 is coupled with the gate line GL1. The mechanical switch S is positioned between the drain of the thin film transistor TFT12 and the common electrode CE. In this embodiment, the mechanical switch S is shared by the upper and lower pixels PXn and PX(n+1). One terminal of the source line is provided with a source driver SD. The source drive SD activates the source line and provides a voltage corresponding to a gray scale to the source line. The other terminal of the source line is provided with a sensing amplifier SA to detect a potential change of the source line.

The operation of the circuit shown in FIG. 3 is described below. As performing a general display function, the voltage corresponding to the aforesaid gray scale is provided to activate the source lines connected with the pixels displaying an object. By activating the gate lines of the aforesaid pixels, the liquid crystal elements of the pixels are twisted to achieve a transmittance corresponding to the gray scale so as to execute the display of the pixels. Thereafter, the gray scale voltages for the pixels of the row of the activated gate line are applied by the respective source lines and the foregoing operation procedure is repeated for the respective rows of the active matrix display apparatus in order to perform display of the entire frame.

As performing the touch sensing function, a voltage is provided to the respective source lines SL, and a pair of gate lines (e.g. GL1 and GL2) in two rows are activated at the same time. Once the switch is turned on, a touch event can be determined by detecting a potential change of the source line SL. In a practical detection, the sensing amplifiers SA operates in a sensing condition to sequentially scan the gate lines of the LCD from top to bottom so as to detect that the switch S is turned on at which column and at which row by the touch event. Then, the touch position can be determined accordingly. Detection of the potential changes of the source lines can be executed by the source driver SD. Alternatively, the aforesaid detection of the potential changes of the source lines can also be executed by both the source driver SD and the sensing amplifier SA.

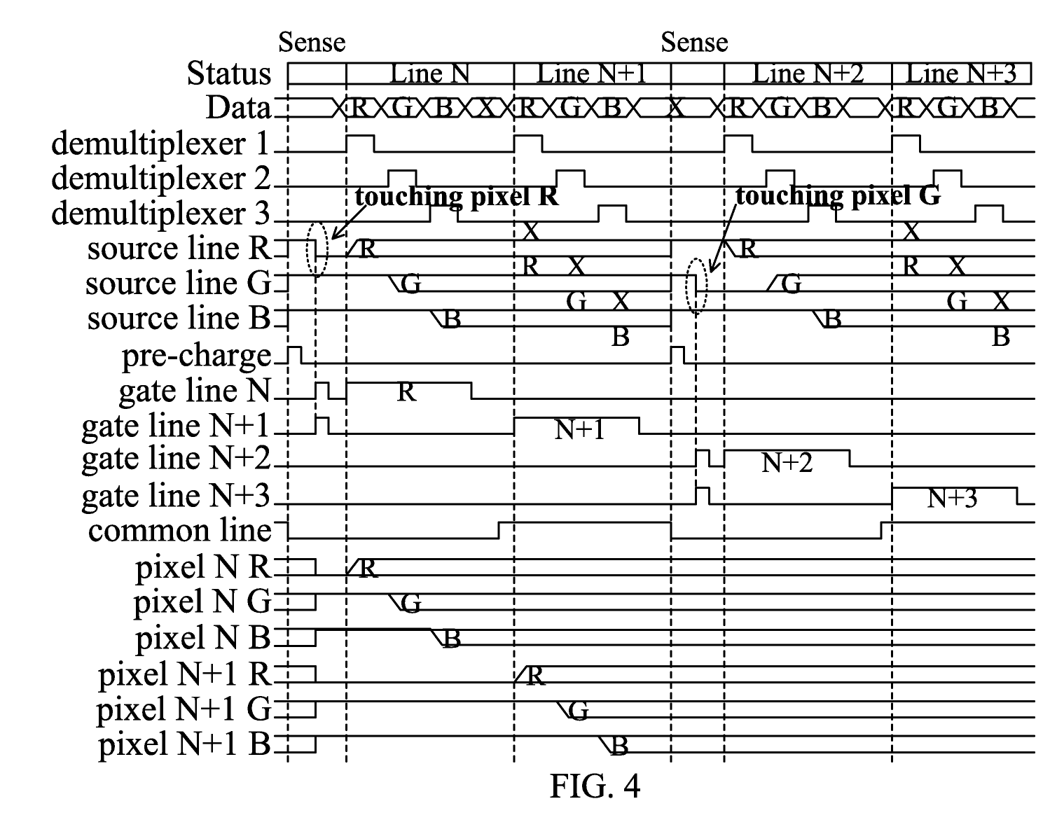

Please refer to FIG. 4, which shows a timing diagram of touch events and display operations of the active matrix display apparatus shown in FIG. 3 when it is a color the active matrix display apparatus. Herein, RGB pixels are read respectively by the respective lines and the touch sensing function is also executed for every two rows at one time to determine whether a touch event occurs or not.

First, the respective rows are pre-charged before the touch sensing function is executed. The source driver SD outputs a voltage having a phase which is reversed to that of the common electrode CE to the source line SL and charges parasitic capacitances of the source lines. When the touch sensing function is executed to the respective rows and the mechanical switches S inside the corresponding pixels are turned on, the potential of the source line SL becomes to be equal to the potential of the common electrode CE. When the touch sensing function is activated to the respective rows and the mechanical switches inside the corresponding pixels are turned off, the potential of the source line SL becomes to be equal to the pre-charging potential. Thereafter, the sensing amplifier SA executes a detection of the voltage of the source line after the touch sensing function is finished and then outputs a corresponding voltage.

As shown in FIG. 4, during the initial sensing period after pre-charging, the gate line N and the gate line N+1 are activated at the same time, and only a potential drop of the red source line R is detected. The touch event to the red pixel R (e.g. touching pixel R) can be determined. Similarly, during the following-up sensing period, the gate line N+2 and the gate line N+3 are activated by the same time, and only a potential drop of the green source line G is detected. The touch event to the green pixel G (e.g. touching pixel G) can be determined.

In the embodiment, an ITO film can be formed as to construct touch part of the mechanical switch as aforementioned. Other conductive materials, such as, a metal film, can also be illustrated. Moreover, the active matrix display apparatus with touch sensing function of the present invention can be applied in electronic equipments, such as a mobile phone, a digital camera, a Personal Digital Assistant, an in-vehicle display, a digital photo frame or a portable DVD player.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An active matrix display apparatus with touch sensing function comprising:
a plurality of pixels arrayed as a matrix, respectively positioned at intersections of source lines of respective columns and gate lines of respective rows, each pixel having a thin film transistor and a liquid crystal element, which is positioned between a drain of the thin film transistor and a common line, wherein sources of the thin film transistors of the pixels are coupled to the source lines and gates thereof are coupled to the gate lines; and
a touch switch unit having two touch sensing transistors and a mechanical switch, the touch switch unit being positioned between two adjacent pixels of an identical column and gates of the two touch sensing transistors being coupled to the gate lines of the two adjacent pixels,
wherein the two touch sensing transistors are coupled in series, the mechanical switch is shared by the two adjacent pixels, the two touch sensing transistors and the mechanical switch are coupled between the source line of the identical column and the common line.

2. The active matrix display apparatus of claim 1, wherein each of the respective pixels further comprises an auxiliary capacitor coupled between the drain of the thin film transistor and an auxiliary capacitor line provided for each of the respective rows.

3. The active matrix display apparatus of claim 1, wherein the two adjacent pixels of the identical column are symmetrically constructed in respect to the gate lines of the two adjacent pixels.

4. The active matrix display apparatus of claim 1, wherein each source line is coupled with a sensing amplifier to detect potential changes of the source line.

5. The active matrix display apparatus of claim 1, wherein the gate lines of the two adjacent pixels of the identical column are both activated when a touch event occurs.

6. An electronic equipment, comprising the active matrix display apparatus of claim 1.
